(19) United States
(12) Patent Application Publication
(10) Pub. No.: US 2014/0162722 A1
(43) Pub. Date: Jun. 12, 2014

(54) HANDHELD ELECTRONIC APPARATUS

(71) Applicant: COMPAL COMMUNICATIONS, INC., Taipei (TW)

(72) Inventor: Ming-Yuan Weng, Taipei (TW)

(73) Assignee: COMPAL COMMUNICATIONS, INC., Taipei (TW)

(21) Appl. No.: 13/762,398

(22) Filed: Feb. 8, 2013

(30) Foreign Application Priority Data
Dec. 6, 2012 (TW) 101145838

(51) Int. Cl. H04M 1/02

(52) U.S. Cl. CPC H04M 1/0206
USPC 455/556.1

(57) ABSTRACT

A handheld electronic apparatus including an upper base module is provided. The upper base module includes a proximity/light sensor and a touch controller. The proximity/light sensor detects a distance between the proximity/light detector and an external object according to a light. The touch controller is coupled to the proximity/light detector for controlling a touch control action on a touch sensor of the handheld electronic apparatus.

### CROSS-REFERENCE TO RELATED APPLICATION

This application claims the priority benefit of Taiwan application serial no. 101145838, filed on Dec. 6, 2012. The entirety of the above-mentioned patent application is hereby incorporated by reference herein and made a part of this specification.

### BACKGROUND OF THE INVENTION

1. Field of the Invention

The present invention relates to a handheld electrical apparatus, and more particularly, to a construction of a proximity/light sensor of a handheld electronic apparatus.

2. Description of Related Art

Following the development of electronic technology, handheld electronic apparatus have become an indispensible tool in people's life. Through the handheld electronic apparatus (e.g. handheld mobile phones), people can quickly obtain desired information or communicate with other people anywhere and anytime, which effectively increases the convenience in people's life.

Referring to FIG. 1, which is a cross-sectional view of a conventional handheld mobile phone 10. The handheld mobile phone 10 is usually mounted with a proximity/light sensor 13 which is used to detect whether the handheld mobile phone approaches an object by detecting a light. In brief, when the proximity/light sensor 13 detects that there is an object approaching the handheld mobile phone 10, it indicates that the handheld mobile phone 10 is in the state of a call connection. At this time, the screen of the handheld mobile phone 10 is not observed by the user and, therefore, the handheld mobile phone may shut off the screen to save power.

However, in the conventional mobile phone, the proximity/light sensor 13 is disposed in a lower base module 11 of the handheld mobile phone 10 and detects the light through an opening 14 formed through an upper base module 12. With such a construction, the error generated by assembly of the handheld mobile phone 10 causes the detection of the proximity/light sensor 13 to be inaccurate. In addition, when the handheld mobile phone 10 is re-assembled, the proximity/light sensor 13 needs to be re-calibrated. Furthermore, limited by the thickness of the upper base module 12, an overlarge air gap AG between the proximity/light sensor 13 and the opening 14 of the upper base module 12 affects the performance of the proximity/light sensor. In addition, an overlarge diameter of the opening 14 of the upper base module 12 also significantly affects the appearance of the handheld mobile phone 10.

### SUMMARY OF THE INVENTION

Accordingly, the present invention is directed to a handheld electronic apparatus which can effectively increase the performance of the proximity/light sensor.

The present invention provides a handheld electronic apparatus including an upper base module. The upper base module includes a proximity/light sensor and a touch controller. The proximity/light sensor detects a distance between the proximity/light detector and an external object according to a light. The touch controller is coupled to the proximity/light detector for controlling a touch control action on a touch sensor of the handheld electronic apparatus.

In one embodiment, the touch controller includes a memory coupled to the proximity/light detector for storing a calibration parameter of the proximity/light detector.

In one embodiment, the memory is a non-volatile memory.

In one embodiment, the handheld electronic apparatus further includes a flexible printed circuit board disposed between the touch controller and the touch sensor for acting as a signal transmission medium between the touch controller and the touch sensor. The proximity/light detector is disposed on the flexible printed circuit board and coupled to the touch controller through the flexible printed circuit board.

In one embodiment, the handheld electronic apparatus further includes a lower base module. The lower base module and the upper base module are overlappingly disposed. The lower base module includes a printed circuit board coupled to the proximity/light detector and the touch controller.

In one embodiment, the printed circuit board is coupled to the touch controller and the proximity/light detector through the flexible printed circuit board.

In view of the foregoing, in the present invention, the proximity/light sensor and the touch controller are commonly disposed in the upper base module. As such, the number of elements necessary for the proximity/light sensor can be reduced, and the diameter of the opening necessary for the proximity/light sensor can also be reduced, which results in an improved appearance of the handheld electronic apparatus. In addition, more importantly, because the proximity/light sensor is disposed in the upper base module, inaccurate calibration of the proximity/light sensor due to the error caused by the assembly of the handheld electronic apparatus can be effectively avoided, which can therefore increase the calibration accuracy of the proximity/light sensor.

Other objectives, features and advantages of the present invention will be further understood from the further technological features disclosed by the embodiments of the present invention wherein there are shown and described preferred embodiments of this invention, simply by way of illustration of modes best suited to carry out the invention.

### BRIEF DESCRIPTION OF THE DRAWINGS

FIG. 1 is a cross-sectional view of a conventional handheld mobile phone 10.

FIG. 2 is a cross-sectional view of a handheld electronic apparatus 20 according to one embodiment of the present invention.

FIG. 3 illustrates a handheld electronic apparatus 100 according to one embodiment of the present invention.

FIG. 4 illustrates the relationship between the proximity/light sensor 111 and the touch controller 112 of the embodiment of FIG. 1.

FIG. 5 illustrates a handheld electronic apparatus 300 according to another embodiment of the present invention.

### DESCRIPTION OF THE EMBODIMENTS

FIG. 2 is a cross-sectional view of a handheld electronic apparatus 20 according to one embodiment of the present invention. The handheld electronic apparatus 20 includes an upper base module 22 and a lower base module 21. A proximity/light sensor 231, a touch controller 232 and a touch sensor 233 are disposed in the upper base module 22, and a printed circuit board 25 is disposed in the lower base module 21. In addition, the upper base module 22 correspondingly form an opening 24 above the proximity/light sensor 231, such that the proximity/light sensor 231 can detect whether there is an external object approaching a surface of the upper base module 22 of the handheld electronic apparatus 20. In addition, the printed circuit board 25 is connected to the proximity/light sensor 231 and touch sensor 232 by a flexible circuit board 23.

It is noted that, because the proximity/light sensor 231 is disposed in the upper base module 22, the air gap between the proximity/light sensor 231 and the opening 24 can be effectively reduced. Therefore, interferences caused by diffraction, refraction and/or scattering of light detected by the proximity/light sensor 231 can also be significantly reduced. In addition, a diameter of the opening 24 can also be effectively reduced, which results in a more aesthetic appearance of the handheld electronic apparatus 20.

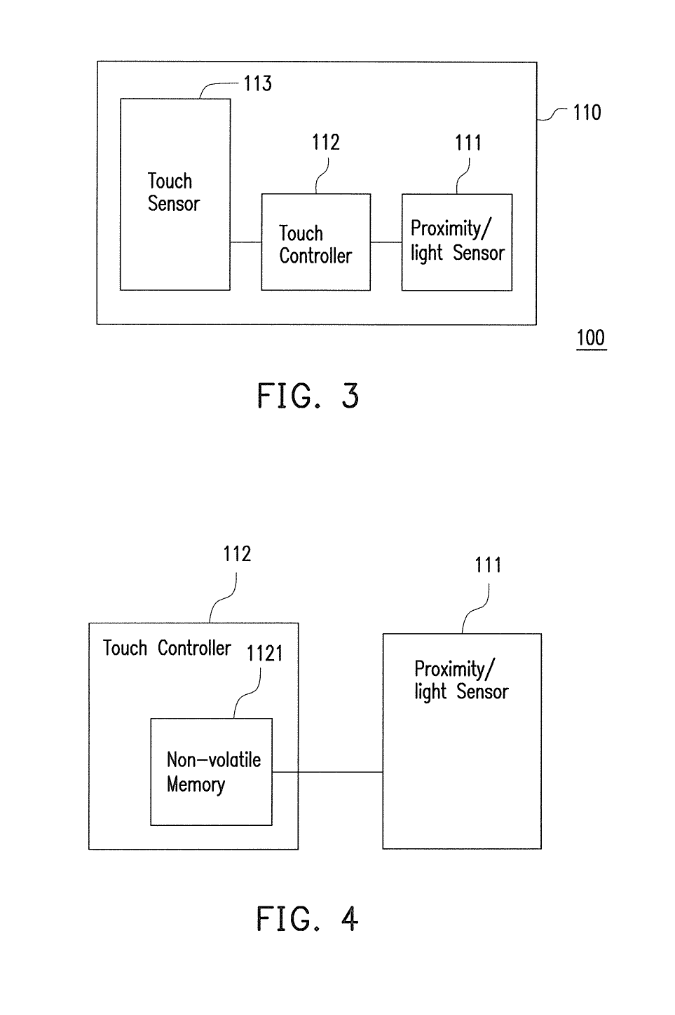

FIG. 3 illustrates a handheld electronic apparatus 100 according to one embodiment of the present invention. The handheld electronic apparatus 100 may be, for example, a handheld mobile phone. The handheld electronic apparatus 100 includes an upper base module 110. The upper base module 110 includes a proximity/light sensor 111, a touch controller 112, and a touch sensor 113. The proximity/light sensor 111 is used to detect a distance between the proximity/light sensor and an external object according to a light. The upper base module 110 correspondingly forms an opening above the proximity/light sensor 111, and the proximity/light sensor 111 can detect the distance between the external object and the proximity/light sensor 111 by detecting a luminance of the light through the opening.

In brief, when the upper base module 110 of the handheld electronic apparatus 100 approaches a user (e.g. the user's face), the luminance of the light received by the proximity/light sensor 111 correspondingly decreases. Therefore, the proximity/light sensor 111 may detect the distance between the user's face and the upper base module 110 according to the decreased light luminance.

In the above embodiment of the present invention, the proximity/light sensor 111, the touch controller 112, and the touch sensor 113 are commonly disposed in the upper base module 110 of the handheld electronic apparatus 100. That is, the proximity/light sensor 111 may approach closer to the position of the upper base module 110 where the user contacts, the air gap of the opening through which the proximity/light sensor 111 receives light may also be effectively reduced, thus reducing the interferences caused by reflection of light and hence increasing the accuracy of the proximity/light sensor 111. Because the distance between the proximity/light sensor 111 and the position of the upper base module 110 where the user contacts, the diameter of the opening may also be effectively reduced, which results in a more aesthetic appearance of the handheld electronic apparatus 20.

In addition, regarding calibration of the proximity/light sensor 111, because the proximity/light sensor 111 is disposed in the upper base module 110 of the handheld electronic apparatus 100, when the upper base module 110 of the handheld electronic apparatus 100 is assembled, the necessary calibration of the proximity/light sensor 111 can be completed at the same time. In addition, calibration of the proximity/light sensor 111 is independent of the assembly of parts other than the upper base module 110 of the handheld electronic apparatus 100 (e.g. the lower base module). That is, the error caused by overall assembly of the handheld electronic apparatus 100 does not affect the accuracy of the calibration of the proximity/light sensor 111. As such, re-assembly of the electronic apparatus 100 does not affect the detection accuracy of the proximity/light sensor 111, and does not require re-calibration of the proximity/light sensor 111.

It is noted that, in the present embodiment, under the condition that the touch controller 112 and the proximity/light sensor 111 are both disposed in the upper base module 110, the calibration of the proximity/light sensor 111 may be conducted together with calibration of the touch controller 112, without separately calibrating the proximate/light detector 111 and the touch controller 112, thus reducing the complexity of production process.

In addition, the touch controller 112 and the proximity/light sensor 111 may also be integrated into a single integrated circuit (IC) to reduce area needed for circuit elements.

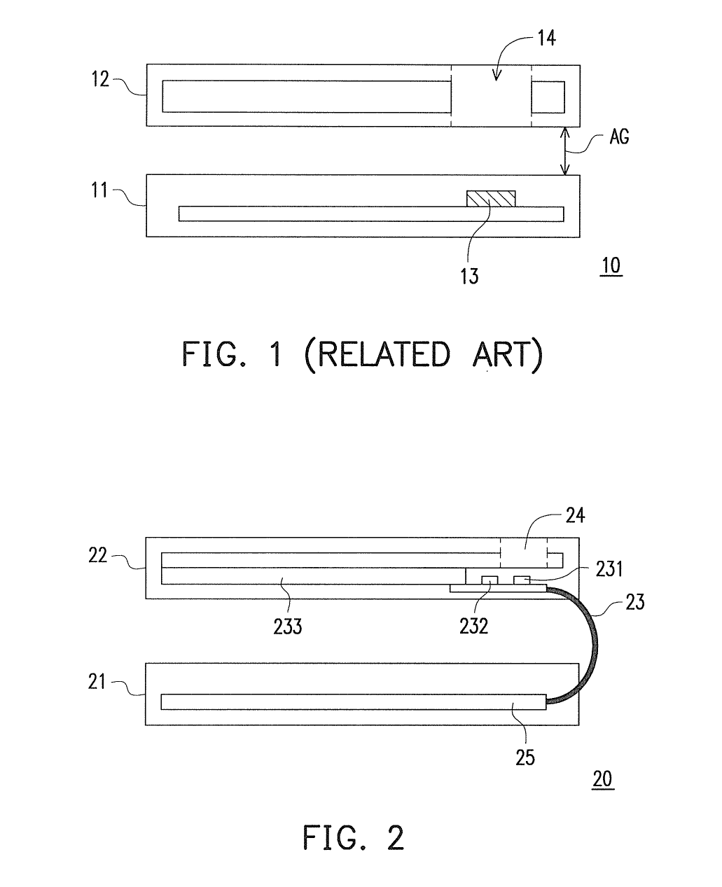

FIG. 4 illustrates the relationship between the proximity/light sensor 111 and the touch controller 112 of the embodiment of FIG. 1. The touch controller 112 includes a non-volatile memory 1121, and the proximity/light sensor 111 may be coupled to the non-volatile memory 1121. It is noted that the non-volatile memory 1121 is used to store setting data needed by the touch controller 112 that controls the touch action detection performed on the touch sensor 113. If the memory space of the non-volatile memory 1121 is not fully used, the spare memory space can be used to store calibration parameters needed by the proximity/light sensor 111 during calibration. In the present embodiment, the calibration parameters may, for example, include the distance between the touch sensor 112 and the proximity/light sensor 111.

In brief, in some embodiments of the present invention, the spare memory space of the existing non-volatile memory 1121 of the touch controller 112 to store the calibration parameters of the proximity/light sensor 111. As such, no additional memory is required to store the calibration parameters and, therefore, cost is effectively reduced. It is to be understood that embodiments of the present invention may also use spare space of another memory of the touch controller 112 to store the calibration parameters of the proximity/light sensor 111 instead of using the non-volatile memory 1121.

In addition, because the memory storing the calibration parameters of the proximity/light sensor 111 and the proximity/light sensor 111 are disposed in the upper base module 110, when the proximity/light sensor 111 needs to be calibrated during repairing of the handheld electronic apparatus 100, the calibration data of the proximity/light sensor 111 can be readily obtained to accomplish the calibration of the proximity/light sensor 111.

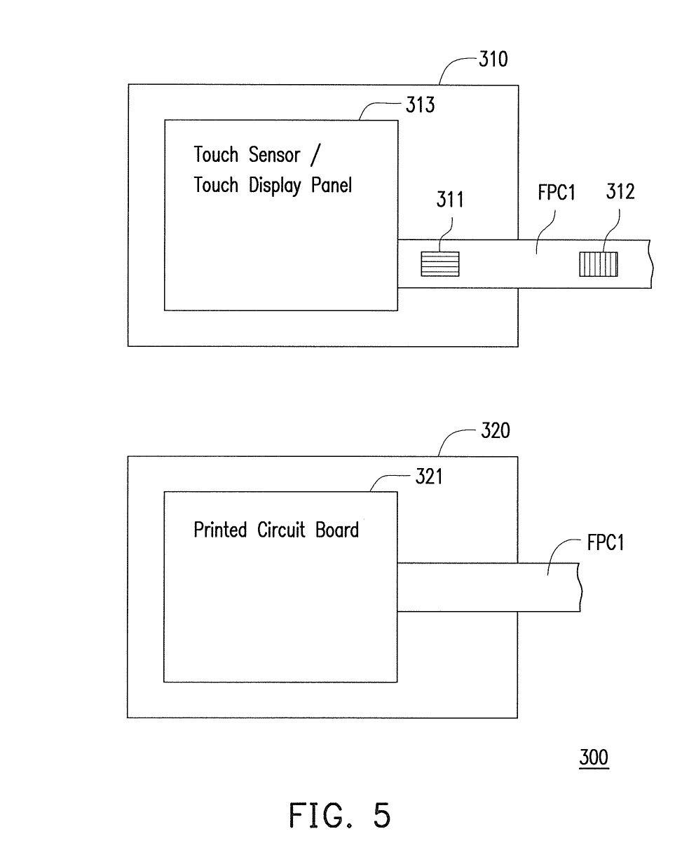

FIG. 5 illustrates a handheld electronic apparatus 300 according to another embodiment of the present invention. The handheld electronic apparatus 300 includes an upper base module 310 and a lower base module 320. The upper base module 310 includes a touch sensor 313, a proximity/light sensor 311, a touch controller 312, and a flexible printed circuit FPC1. The touch sensor 313 may be a touch display panel which integrates touch control and display functions. The flexible printed circuit board FPC1 is disposed between the touch controller 312 and the touch sensor 313 and acts as a signal transmission medium between the touch controller 312 and the touch sensor 313. In addition, the proximity/light sensor 311 is disposed on the flexible printed circuit board FPC1 and is coupled to the touch controller 312 through the flexible printed circuit board FPC 1.

The upper base module 310 and the lower base module 320 are overlappingly disposed. The lower base module 320 includes a printed circuit board 321. The printed circuit board 321 is coupled to the proximity/light sensor 311 and the touch controller 312 through the flexible circuit board FPC1.

In summary, in the present invention, the proximity/light sensor and the touch controller are integrated into the upper base module. With this construction, the opening of the handheld electronic apparatus does not need a large diameter, and its air gap can also be reduced. In addition, the error caused by the assembly of the handheld electronic apparatus does not affect the calibration accuracy of the proximity/light sensor. The present invention is beneficial in the improvement of the appearance of the handheld electronic apparatus, the performance of the proximity/light sensor and the convenience in production as well as the reduction of the production cost.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims and their equivalents.

What is claimed is:

1. A handheld electronic apparatus comprising:
an upper base module, comprising:
a proximity/light sensor detecting a distance between the proximity/light sensor and an external object according to a light; and
a touch controller coupled to the proximity/light sensor for controlling a touch control action on a touch sensor of the handheld electronic apparatus; and
a lower base module, wherein the upper base module and the lower base module are overlapped.

2. The handheld electronic apparatus according to claim 1, wherein the touch controller comprises a memory coupled to the proximity/light sensor for storing a calibration parameter of the proximity/light sensor.

3. The handheld electronic apparatus according to claim 2, wherein the memory is a non-volatile memory.

4. The handheld electronic apparatus according to claim 1, wherein the lower base module comprises a printed circuit board coupled to the proximity/light sensor and the touch controller.

5. The handheld electronic apparatus according to claim 1, further comprising a flexible printed circuit board disposed between the touch controller and the touch sensor, and the flexible printed circuit board acting as a signal transmission medium between the touch controller and the touch sensor, wherein the proximity/light sensor is disposed on the flexible printed circuit board and the proximity/light sensor is coupled to the touch controller through the flexible printed circuit board.

6. The handheld electronic apparatus according to claim 5, wherein the printed circuit board is coupled to the touch controller and the proximity/light sensor through the flexible printed circuit board.
